(19) United States
(12) Patent Application Publication
(10) Pub. No.: US 2022/0327178 A1
(43) Pub. Date: Oct. 13, 2022

(54) DISPLAYING ADDITIONAL INFORMATION REGARDING PHYSICAL ITEMS

(71) Applicant: ARRIS Enterprises LLC, Suwanee, GA (US)

(72) Inventor: Mark ROBERTS, London (GB)

(73) Assignee: ARRIS Enterprises LLC, Suwanee, GA (US)

(21) Appl. No.: 17/716,795

(22) Filed: Apr. 8, 2022

Related U.S. Application Data
(60) Provisional application No. 63/173,174, filed on Apr. 9, 2021.

(51) Int. Cl. G06F 16/955; G06F 17/40; G06K 7/14; G06T 1/00

(52) U.S. Cl. CPC G06F 16/9554; G06F 17/40; G06K 7/1417; G06T 1/0007

(57) ABSTRACT

Methods and systems of displaying additional information on a physical item having a Quick Response (QR) code are shown and disclosed. In one embodiment, the method includes displaying a stream of first images of the item, and scanning the QR code of the item. The method additionally includes extracting data from the scanned QR code. The data is associated with the item. The method further includes overlaying the extracted data on the displayed stream of first images.

### CROSS REFERENCE TO RELATED APPLICATIONS

This application claims the benefit of U.S. Provisional Patent Application Ser. No. 63/173,174 filed Apr. 9, 2021.

### BACKGROUND

The subject matter of this application relates to displaying additional information regarding physical assets or items, in particular systems and methods of displaying additional information regarding physical assets or items with Quick Response (QR) codes.

Facilities and other locations that store various physical assets or items must label those items to allow persons to identify the items and obtain additional information regarding those items. Generally, physical labels are used on those items. However, any additional information placed on physical labels for the items may become stale and obsolete requiring re-labelling of those items. Additionally, when the item is a package having one or more contents, the physical labels generally are not large enough to provide a user with sufficient visual information regarding the contents. There have been systems proposed that require the use of specialized equipment, such as a head mounted display connected to a laptop, to visually recognize items. However, those systems are generally expensive and do not provide real-time information regarding the items.

What is desired, therefore, are systems and/or methods that provide or display additional information (e.g., real-time information) regarding physical assets or items without the need for specialized equipment.

### BRIEF DESCRIPTION OF THE DRAWINGS

For a better understanding of the invention, and to show how the same may be carried into effect, reference will now be made, by way of example, to the accompanying drawings, in which:

FIG. 1 is a high-level block diagram of an example of a network to facilitate displaying additional information on a physical item having a QR code.

FIG. 2 is a flowchart illustrating an example process of displaying additional information on a physical item having a QR code.

FIGS. 3-6 are various perspective views of an example of displaying additional information on a physical item having a QR code.

FIG. 7 is a block diagram of an example of a hardware configuration operable to facilitate displaying additional information on a physical item having a QR code.

### DETAILED DESCRIPTION

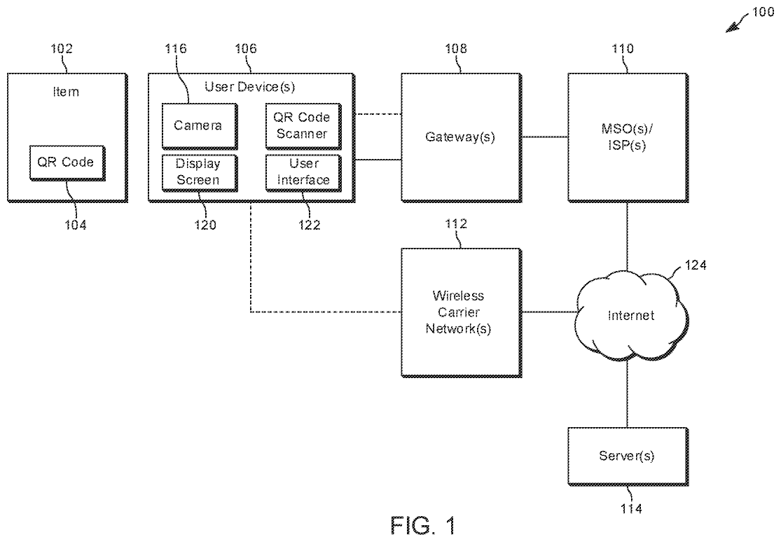

Referring to FIG. 1, an example network environment 100 for displaying additional information on a physical item 102 having a QR code 104. The QR code may be on a label attached to the physical item, printed on the physical item, etc. Network environment 100 includes one or more user devices 106, gateways 108, Multiple System Operator (MSO) and/or Internet Service Provider (ISP) systems 110, wireless carrier networks 112, and servers 114.

User devices 106 include desktop computers, smart phones, tablet computers, smart watches and other wearables, gaming systems, etc. The user devices may include a camera 116, a QR code scanner 118, a display screen 120, and/or a user interface 122 (e.g., graphical user interface (GUI)). QR code scanner 118 may be separate from camera 108 and may scan QR codes separate from camera 116. Alternatively, or additionally, QR code scanner 118 may analyze images from camera 116 (or an associated camera application) and detect and/or scan QR codes in those images. Instead of a separate QR code scanner, user device may alternatively, or additionally, have camera 116 and/or its associated camera application have the ability or feature of scanning QR codes. When user interface 122 is a GUI, the GUI may be accessed by the user via display screen 120 of the device.

Gateway 108 includes any gateway and/or networking hardware device(s) that provide one or more wired and/or wireless access points to user devices 106 via a wired connection to, for example, a router. In other words, gateway 108 allows user devices 106 to connect to a wired network with access to Internet 122. MSO/ISP systems 110 may include one or more headends, regional headends, a network architecture of fiber optic, twisted pair, and/or co-axial lines, and/or amplifiers. MSO/ISP systems 110 may additionally, or alternatively, include a Point of Presence (POP) that connect to Network Access Points (NAP), such as via routers and a T3 backbone. Wireless carrier networks 112 may include base transceiver stations, base station controllers, mobile service switching centers, and fixed-line telephone networks to connect to Internet 124. Servers 114 provide content, including additional information regarding the item having the QR code, to user devices 106.

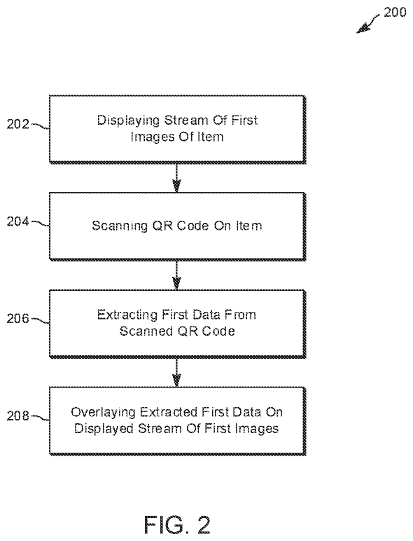

Referring to FIG. 2, a flowchart is shown of an example method or process 200 of displaying additional information on a physical item having a Quick Response (QR) code, which may be performed, for example, by user devices 106. At 202, a stream of first images of a physical item is displayed. For example, a camera of the user device can capture a stream of first images of the item and display that captured stream on a display screen of the user device. At 204, a QR code of the item is scanned. The QR code may be scanned independently of the camera, such as via a QR code scanner of the user device. Alternatively, or additionally, the QR code may be scanned by the QR code scanner or application from the first images captured from the camera and/or displayed on the display screen of the user device. A camera application of the user device may alternatively, or additionally, have a feature that allows scanning of QR codes from the first images captured from the camera and/or displayed on the displayed screen of the user device.

At 206, data associated with the item is extracted from the scanned QR code. For example, the user device may extract text, a Uniform Resource Identifier (URI), and/or other data from the scanned QR code. When a URI, such as a Uniform Resource Locator (URL), is extracted from the QR code, the user device may also extract data associated with the extracted URI. The extracted data may be text, image(s), and/or other data associated with the item. When a URI is extracted from the QR code, data associated with the URI is extracted from one or more server(s), which may include, for example, information regarding the item. The information may be real-time information because it is stored on the server and not on a physical label on the item. For example, the information may be inventory information, status information, cost information, size information, network information, capacity information, one or more 2-D or 3-D images depicting the item or one or more contents of the item (such as when the item is packaging), etc.

At 208, the extracted data is overlayed on the displayed stream of first images. For example, the extracted data may be overlayed on the captured stream first images such that both the stream of first images and the extracted data may be viewed at the same time, such as on a display screen of the user device. When the extracted data is text, the text may be overlayed on the stream of first images. When the extracted data are second image(s), the second image(s) may be overlayed on the stream of first images. In other words, the text and/or second image(s) are added as one or more layers of virtual objects in a real environment that shows the physical item (such as in augmented reality interactive experiences).

Method 200 may, in some embodiments, include, changing one or more properties of the item in the displayed stream of first images and changing those propert(ies) of the overlayed data in proportion and/or in response to the change of propert(ies) of the item in the displayed stream of images. For example, the user device may be moved toward or away from the item and/or moved around the item to change the size and/or orientation of item in the displayed stream of images. In response, the user device may change the size and/or orientation of the overlayed data in response to and/or in proportion to the above change(s). The above features allow the user to view, for example, an image associated with the physical item in different angles, viewpoints, magnifications, etc. In other embodiments, the properties of the overlayed data, such as size and/or orientation, may not be changed or may be changed but not in proportion to the changes to the item displayed in the stream of images. Although FIG. 2 shows particular steps for a process of displaying additional information on a physical item, other examples of the process may add, omit, replace, repeat, and/or modify one or more steps.

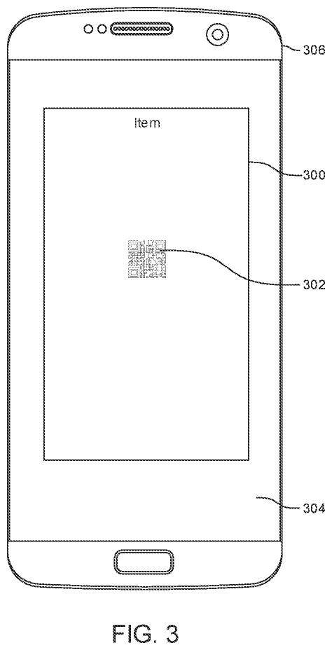

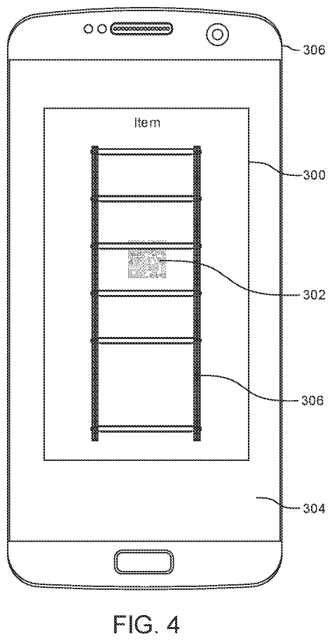

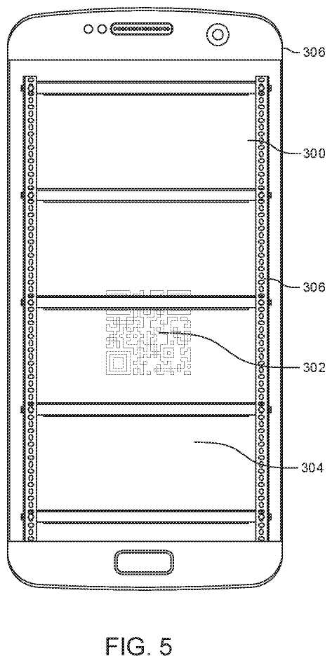

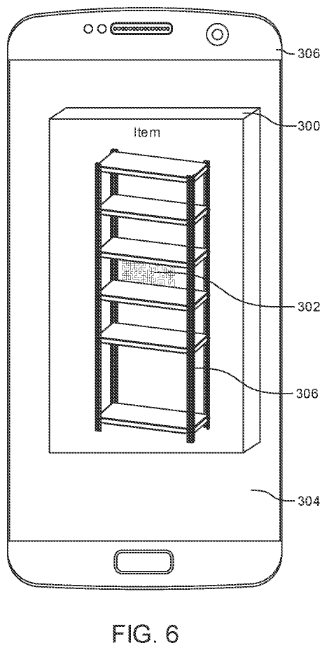

Referring to FIGS. 3-6, an example of displaying additional information on a physical item (e.g., package) via, for example, method 200 is shown. In FIG. 3, a stream of first images of a package 300 having a QR code 302 is displayed on a display screen 304 of a smart phone 306. The QR code is detected and scanned, such as via a QR code scanner or application of the smart phone. A URI is extracted from the scanned QR code and a 3-D image 306 of the contents of the package is extracted from the URI. In FIG. 4, the 3-D image extracted from the URI is overlayed on the item on the display screen. In FIG. 5, the smart phone is moved toward the item, which increases the size of the package on the display screen and also increases the size of the contents of the package in the overlayed 3-D image. In FIG. 6, the smart phone is moved around the package, which changes the orientation of the package on the display screen and also changes the orientation of the contents of the package in the overlayed 3-D image.

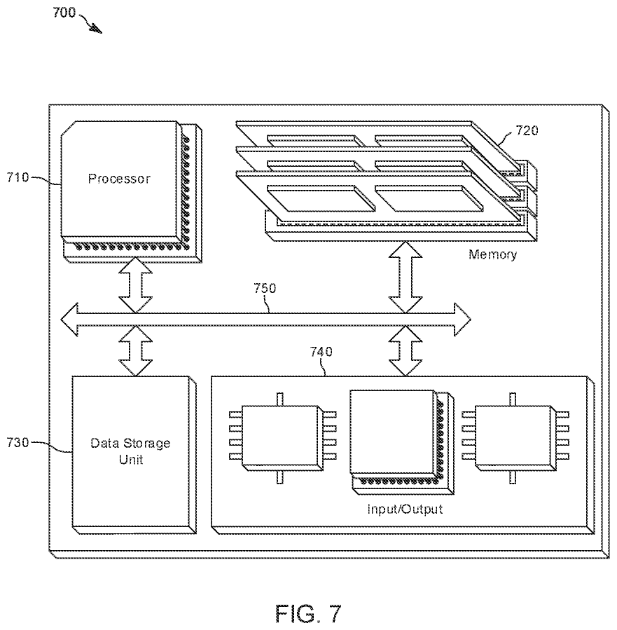

Referring to FIG. 7, a hardware configuration 700 operable to facilitate automatically updating stored content is shown. The hardware configuration may be configured to implement or execute one or more of the processes performed by any of the various components, engines, applications, and devices described in the present disclosure, including user devices 106, camera 116, and/or QR code scanner 118. The hardware configuration 700 may include a processor 710, memory 720, a storage device 730, and an input/output device 740. Each of the components 710, 720, 730, and 740 may, for example, be interconnected using a system bus 750. The processor 710 may be capable of processing instructions for execution within the hardware configuration 700. In one implementation, the processor 710 may be a single-threaded processor. In another implementation, the processor 710 may be a multi-threaded processor. The processor 710 may be capable of processing instructions stored in the memory 720 or on the storage device 730.

The memory 720 may store information within the hardware configuration 700. In one implementation, the memory 720 may be a computer-readable medium. In one implementation, the memory 720 may be a volatile memory unit. In another implementation, the memory 720 may be a non-volatile memory unit. In some implementations, the storage device 730 may be capable of providing mass storage for the hardware configuration 700. In one implementation, the storage device 730 may be a computer-readable medium. In various different implementations, the storage device 730 may, for example, include a hard disk device, an optical disk device, flash memory or some other large capacity storage device. In other implementations, the storage device 430 may be a device external to the hardware configuration 700.

The input/output device 740 provides input/output operations for the hardware configuration 700. In embodiments, the input/output device 740 may include one or more of a network interface device (e.g., an Ethernet card), a serial communication device (e.g., an RS-232 port), one or more universal serial bus (USB) interfaces (e.g., a USB 2.0 port), one or more wireless interface devices (e.g., an 802.11 card), and/or one or more interfaces for outputting video and/or data services to a CPE device, IP device, mobile device, or other device. In embodiments, the input/output device may include driver devices configured to send communications to, and receive communications from an advertisement decision system, an advertisement media source, and/or a CDN.

The subject matter of this disclosure, and components thereof, may be realized by instructions that upon execution cause one or more processing devices to carry out the processes and functions described above. Such instructions may, for example, comprise interpreted instructions, such as script instructions, e.g., JavaScript or ECMAScript instructions, or executable code, or other instructions stored in a computer readable medium.

Implementations of the subject matter and the functional operations described in this specification may be provided in digital electronic circuitry, or in computer software, firmware, or hardware, including the structures disclosed in this specification and their structural equivalents, or in combinations of one or more of them. Embodiments of the subject matter described in this specification may be implemented as one or more computer program products, i.e., one or more modules of computer program instructions encoded on a tangible program carrier for execution by, or to control the operation of, data processing apparatus.

A computer program (also known as a program, software, software application, script, or code) may be written in any form of programming language, including compiled or interpreted languages, or declarative or procedural languages, and it may be deployed in any form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a mark-up language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows may also be performed by, and apparatus may also be implemented as, special purpose logic circuitry, e.g., an FPGA (field programmable gate array) or an ASIC (application specific integrated circuit).

Computer readable media suitable for storing computer program instructions and data include all forms of non-volatile memory, media, and memory devices, including by way of example semiconductor memory devices (e.g., EPROM, EEPROM, and flash memory devices); magnetic disks (e.g., internal hard disks or removable disks); magneto optical disks; and CD ROM and DVD ROM disks. The processor and the memory may be supplemented by, or incorporated in, special purpose logic circuitry.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Particular embodiments of the subject matter described in this specification have been described. Other embodiments are within the scope of the following claims. For example, the actions recited in the claims may be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

The systems and methods of the present disclosure can be used to identify issues proactively, such as single points of failure, data center fiber points of entry, capacity management, etc., and/or reactively, such as network faults. The above issues can be identified more successfully and more quickly and/or easily with one user device (such as a smartphone with a single augmented reality application) and without the need for a laptop, expensive head mounted displays, and multiple applications to crossmatch records, which would be impractical for a field engineer to use while moving around a large facility (such as a data center). Additionally, the systems and methods of the present disclosure can more quickly and easily recognize items, such as racks and other equipment over other systems that use vision recognition software and/or GPS or wireless triangulation. For example, most racks look the same so recognition of objects via vision recognition software systems is impractical. Additionally, GPS or wireless triangulation systems are not accurate enough and poor signal quality inside facilities makes those systems impractical.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A method of displaying additional information on a physical item having a Quick Response (QR) code, comprising:
displaying a stream of first images of the item;
scanning the QR code of the item;
extracting data from the scanned QR code, the data being associated with the item; and
overlaying the extracted data on the displayed stream of first images.

2. The method of claim 1, further comprising:
changing size of the item in the displayed stream of first images; and
changing size of the overlayed data in proportion and in response to the change of size of the item in the displayed stream of first images.

3. The method of claim 1, wherein displaying a stream of first images of the item includes:
capturing the stream of first images of the item with a camera; and
displaying the captured stream of first images of the item on a display screen.

4. The method of claim 3, further comprising:
detecting movement of the camera toward or away from the item; and
changing size of the overlayed data based on the detected movement.

5. The method of claim 3, further comprising:
detecting movement of the camera around the item; and
changing orientation of the overlayed data based on the detected movement.

6. The method of claim 1, wherein extracting data from the detected QR code includes extracting text from the detected QR code.

7. The method of claim 1, wherein extracting data from the detected QR code includes:
extracting a Uniform Resource Identifier from the detected QR code; and
extracting data associated with the URI.

8. The method of claim 7, wherein overlaying the extracted data on the displayed stream of first images includes overlaying a second image associated with the URI.

9. The method of claim 8, wherein overlaying a second image associated with the URI includes overlaying a three-dimensional image associated with the URI.

10. The method of claim 1, wherein scanning the QR code includes scanning the QR code from the stream of first images.

11. The method of claim 1, wherein the item is a package and wherein the data is a second image of one or more internal contents of the package.

12. The method of claim 11, wherein the second image is a three-dimensional image of the one or more internal contents of the package.

13. The method of claim 11, further comprising:
changing size of the item in the displayed stream of first images; and
changing size of the second image in proportion and in response to the change of size of the item in the displayed stream of first images.

14. The method of claim 11, further comprising:
changing orientation of the item in the displayed stream of first images; and
changing orientation of the second image in proportion and in response to the change of orientation of the item in the displayed stream of first images.
